(19) United States
(12) Patent Application Publication
(10) Pub. No.: US 2010/0073295 A1
(43) Pub. Date: Mar. 25, 2010

(54) MULTIPLE FUNCTION KEYBOARD

(75) Inventor: ZI-YU ZHAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/261,022

(22) Filed: Oct. 29, 2008

(30) Foreign Application Priority Data
Sep. 25, 2008 (CN) 200810304673.0

(51) Int. Cl. G06F 3/02

(52) U.S. Cl. 345/168

(57) ABSTRACT

A keyboard includes a speaker, a clock module, a sound storage module, and a processor. The clock module is configured for outputting a clock signal. The sound storage module is configured for storing an alarm file. The processor is connected to a power terminal of the keyboard, the clock module, the sound storage module, and the at least one speaker. The processor receives voltage from the power terminal of the keyboard and the clock signal from the clock module and reads the alarm file from the sound storage module at every internal of a predetermined time period according to the clock signal, and processes the alarm file to be outputted via the speaker.

### BACKGROUND

1. Technical Field

The present disclosure relates to keyboards and, particularly, to a keyboard having multiple functions.

2. Description of Related Art

A contemporary keyboard as an input device has very simple functions. Keyboard designers often focus on improving keys of the keyboard rather than enabling other uses for the keyboard.

What is needed, is a keyboard which has functions other than just data input.

### BRIEF DESCRIPTION OF THE DRAWINGS

FIG. 1 is a top plan view of an embodiment of a keyboard.

FIG. 2 is a block diagram of the keyboard of FIG. 1.

### DETAILED DESCRIPTION

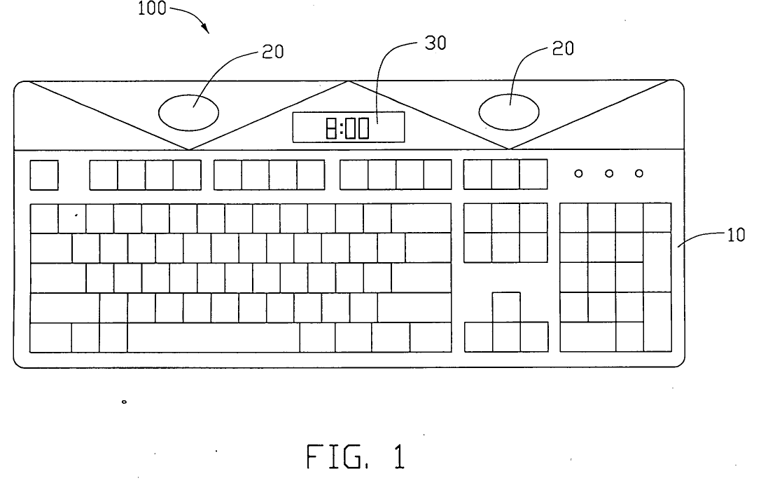

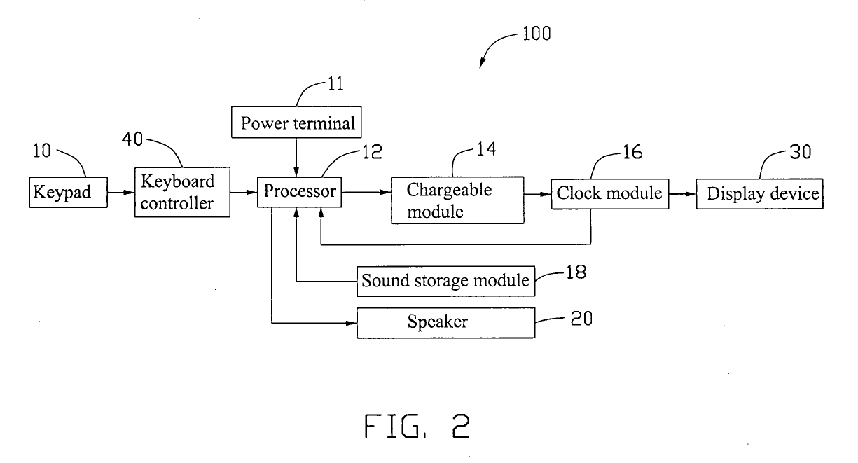

Referring to FIGS. 1 and 2, an embodiment of a keyboard 100 of the present disclosure is shown. The keyboard 100 may be used in conjunction with a computer for inputting various data to the computer. In one embodiment, the keyboard 100 includes a keypad 10, two speakers 20, a display device 30, a keyboard controller 40, a processor 12, a chargeable module 14, a clock module 16, and a sound storage module 18.

The configuration of keys of the keypad 10 may be substantially the same as contemporary keyboards. The speakers 20 and the display device 30 are mounted adjacent the keypad 10. The display device 30 is located between the speakers 20. The keypad 10 is configured to input data. The display device 30 is configured to display time. The speakers 20 are configured to output and audible alarm and/or music.

In one embodiment, the display device 30 may be a liquid crystal display (LCD) screen. The chargeable module 14 may be a rechargeable battery. The sound storage module 18 stores alarm files and music files. The speakers 20 and the display device 30 can be arranged in other locations of the keyboard 100 according to need.

The processor 12 is connected to a power terminal 11 of the keyboard 100, the chargeable module 14, the clock module 16, the sound storage module 18, and the speakers 20. The chargeable module 14 is connected to the clock module 16. The clock module 16 is connected to the display device 30. The processor 12 is connected to the keypad 10 via the keyboard controller 40.

When the computer is booted up, the processor 12 receives voltage from the power terminal 11 of the keyboard 100 and charges the chargeable module 14. The chargeable module 14 provides the voltage to the clock module 16. The clock module 16 displays time via the display device 30, and outputs a clock signal to the processor 12. The processor 12 reads one of the alarm files from the sound storage module 18 at every interval of a predetermined time period (such as one hour) according to the clock signal and processes the one of the alarm files to be outputted via the speakers 20, such as “you have worked for one hour, please take a break to protect your eyes”. The music files of the sound storage module 18 can be reproduced by pressing a predetermined music hot key on the keypad 10. When the music hot key is pressed, a command instruction is sent from the music hot key to the keyboard controller 40 for signaling the keyboard controller 40 to signal the processor 12 to read one of the music files from the sound storage module 18, and process the one of the music files to be played via the speakers 20. When the music hot key is pressed again, the processor 12 stops processing the one of the music files. In one embodiment, the music hot key may be a combination of the “Ctrl+Enter” keys. Music selection hot keys are left arrow key and the right arrow key. Other keys of the keypad 10 can also be adopted as the music hot key and the music selection hot keys according to preference.

When the computer is not booted up, the chargeable module 14 provides voltage to the clock module 16. The clock module 16 displays time via the display device 30.

When the computer is booted up, the keyboard 100, in addition to data input, may also have alarm and music control functions.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A keyboard comprising:
at least one speaker;
a clock module configured for outputting a clock signal;
a sound storage module configured for storing at least one alarm file; and
a processor connected to a power terminal of the keyboard, the clock module, the sound storage module, and the at least one speaker;
wherein the processor is configured to receive voltage from the power terminal of the keyboard and a clock signal from the clock module, and read the least one alarm file from the sound storage module at every internal of a predetermined time period according to the clock signal, and process the at least one alarm file to be outputted via the at least one speaker.

2. The keyboard of claim 1, further comprising a keypad and a keyboard controller, wherein the sound storage module further storing at least one music file and the processor is connected to the keypad via the keyboard controller, the processor is further configured to receive a command instruction from the keypad and read the at least one music file from the sound storage module according to the command instruction, and process the at least one music file to be played via the at least one speaker.

3. The keyboard of claim 2, wherein the keypad comprises a Ctrl key, an Enter key, a left arrow key, and a right arrow key, a combination of the “Ctrl+Enter” keys of the keypad is configured to control the at least one music file to be played and stopped, the left arrow key and the right arrow key of the keypad are configured to control selection of the at least one music file.

4. The keyboard of claim 1, further comprising a chargeable module and a display device, wherein the chargeable module is connected between the processor and the clock module, the display device is connected to the clock module for displaying time, the power terminal of the keyboard is capable of charging the chargeable module via the processor, the chargeable module is capable of providing voltage to the clock module.

5. The keyboard of claim 4, wherein the at least one speaker comprises two speakers, the speakers and the display device are mounted adjacent the keypad, the display device is located between the speakers.

6. The keyboard of claim 4, wherein the chargeable module is a rechargeable battery.

7. The keyboard of claim 4, wherein the display device is a liquid crystal display.

8. A computer system, comprising:
a keyboard comprising:
a keypad;
a keyboard controller connected to the keypad;
at least one speaker;
a clock module configured for outputting a clock signal;
a sound storage module configured for storing at least one alarm file; and
a processor connected to a power terminal of the keyboard, the keyboard controller, the clock module, the sound storage module, and the at least one speaker;
wherein the processor is configured to receive voltage from the power terminal of the keyboard and a clock signal from the clock module, and read the least one alarm file from the sound storage module at every internal of a predetermined time period according to the clock signal, and process the at least one alarm file to be outputted via the at least one speaker.

9. The computer system of claim 8, wherein the sound storage module further storing at least one music file; the processor is further configured to receive a command instruction from the keypad and read the at least one music file from the sound storage module according to the command instruction, and process the at least one music file to be played via the at least one speaker.

10. The computer system of claim 9, wherein the keypad comprises a Ctrl key, an Enter key, a left arrow key, and a right arrow key, a combination of the “Ctrl+Enter” keys of the keypad is configured to control the at least one music file to be played and stopped, the left arrow key and the right arrow key of the keypad are configured to control selection of the at least one music file.

11. The computer system of claim 8, further comprising a chargeable module and a display device, wherein the chargeable module is connected between the processor and the clock module, the display device is connected to the clock module for displaying time, the power terminal of the keyboard is capable of charging the chargeable module via the processor, the chargeable module is capable of providing voltage to the clock module.

12. The computer system of claim 11, wherein the at least one speaker comprises two speakers, the speakers and the display device are mounted adjacent the keypad, the display device is located between the speakers.

13. The computer system of claim 11, wherein the chargeable module is a rechargeable battery.

14. The computer system of claim 11, wherein the display device is a liquid crystal display.
